(19) United States
(12) Patent Application Publication
(10) Pub. No.: US 2018/0052482 A1
(43) Pub. Date: Feb. 22, 2018

(54) VEHICLE PEDAL RELEASE SYSTEM

(71) Applicant: Kenneth P McHugh, Canton, MI (US)

(72) Inventor: Kenneth P McHugh, Canton, MI (US)

(21) Appl. No.: 15/242,778

(22) Filed: Aug. 22, 2016

(51) Int. Cl. G05G 1/327; B60T 7/06; B60K 23/02

(52) U.S. Cl. CPC G05G 1/327; B60K 23/02; B60T 7/065

(57) ABSTRACT

A pedal release system includes a pedal bracket configured to couple to a vehicle dash panel, a pivot pin received within the pedal bracket and defining a first rotational axis, a pedal arm configured to rotate about the first rotational axis, an activation bracket coupled to a stationary structural component of the vehicle, and a pedal release lever coupled to the pedal bracket and movable between a first position and a second position. The pedal release lever includes a contact lever, a pivot release arm, and a pivot push arm. In the first position the pivot release arm facilitates maintaining the pivot pin within the pedal bracket. Upon an impact event where the contact lever is brought into contact with the activation bracket, the pedal release lever is moved to the second position where the pivot push arm urges the pivot pin out of the pedal bracket.

### FIELD

The present application relates generally to vehicle pedal assemblies and, more particularly, to a pedal release system for a vehicle pedal assembly.

### BACKGROUND

During a vehicle frontal impact event, portions of the vehicle may be urged or pushed rearward and may potentially cause a brake and/or clutch pedal to intrude into a passenger area of the vehicle and possibly transfer a force to a foot or leg of a driver of the vehicle. Systems have been developed to mechanically disengage the pedals in an effort to prevent the pedals from potentially being forced into the passenger area during such an impact event. These systems typically rely only gravity to disengage the pedals. While such systems work well for their intended purpose, there remains a desire in the relevant art to have the mechanical disengagement of the pedals be even more responsive.

### SUMMARY

In one exemplary aspect of the invention, a pedal release system for a vehicle is provided. In an example implementation, the pedal release system includes a pedal bracket configured to couple to a vehicle dash panel, a pivot pin received within the pedal bracket and defining a first rotational axis, a pedal arm configured to rotate about the first rotational axis, an activation bracket coupled to a stationary structural component of the vehicle, and a pedal release lever coupled to the pedal bracket and movable between a first position and a second position. The pedal release lever includes a contact lever, a pivot release arm, and a pivot push arm. In the first position the pivot release arm facilitates maintaining the pivot pin within the pedal bracket. Upon an impact event where the contact lever is brought into contact with the activation bracket, the pedal release lever is moved to the second position where the pivot push arm urges the pivot pin out of the pedal bracket to release the pedal arm from the pedal bracket so as to prevent intrusion of the pedal arm into a passenger area of an interior of the vehicle.

In another exemplary aspect of the invention, a vehicle is provided. The vehicle includes a dash panel and a pedal release system. The pedal release system includes, in one example implementation, a pedal bracket coupled to the dash panel, a pivot pin received within the pedal bracket and defining a first rotational axis, a pedal arm configured to rotate about the first rotational axis, an activation bracket coupled to a stationary structural component of the vehicle, and a pedal release lever coupled to the pedal bracket and movable between a first position and a second position. The pedal release lever includes a contact lever, a pivot release arm, and a pivot push arm. In the first position the pivot release arm facilitates maintaining the pivot pin within the pedal bracket. Upon an impact event where the contact lever is brought into contact with the activation bracket, the pedal release lever is moved to the second position where the pivot push arm urges the pivot pin out of the pedal bracket to release the pedal arm from the pedal bracket so as to prevent intrusion of the pedal arm into a passenger area of an interior of the vehicle.

### BRIEF DESCRIPTION OF DRAWINGS

FIG. 1 is a perspective view of an example pedal release system in accordance with the principles of the present application;

FIG. 2 is a perspective view of a portion of the system shown in FIG. 1 in a first position in accordance with the principles of the present application;

FIG. 3 is a perspective view of a portion of the system shown in FIG. 1 in a second position in accordance with the principles of the present disclosure;

FIG. 4 is a side view of the pedal release system in the first position in accordance with the principles of the present disclosure;

FIG. 5 is a side view of the pedal release system in the second position in accordance with the principles of the present disclosure; and

FIG. 6 is a perspective view of the pedal release system with a brake pedal released in accordance with the principles of the present disclosure.

### DESCRIPTION

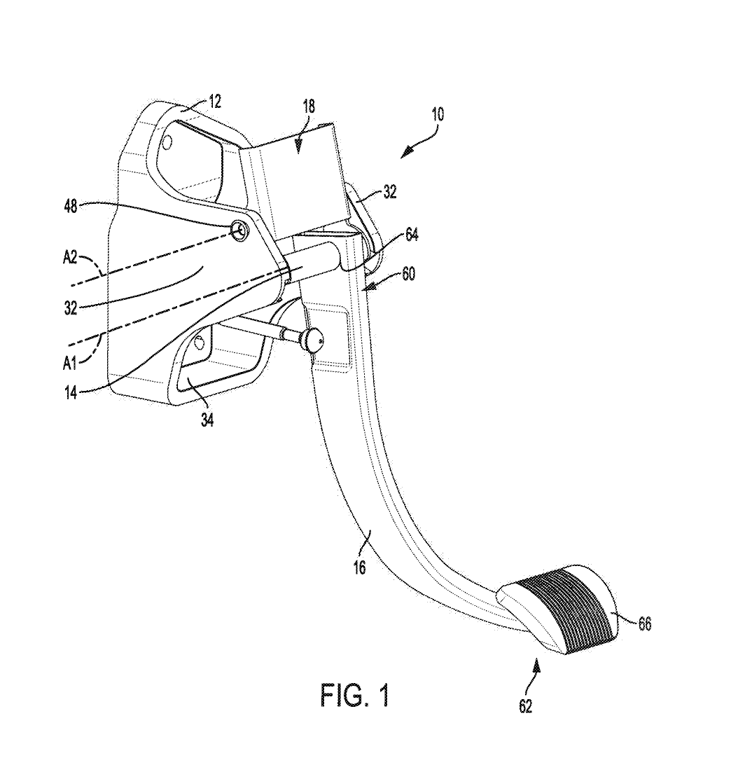

With initial reference to FIG. 1, an example pedal release system for a vehicle is illustrated and generally identified at reference numeral 10. The pedal release system 10 is mechanically activated when the dash panel, pushed rearward towards the driver by a frontal impact, pushes pedal release system 10 into a stationary bracket. Thus, physical movement of the pedal release system 10 causes its activation by releasing the pedal pivot from the main bracket housing and mechanically pushing the pivot from the bracket at the equivalent speed of the impact. In this way, the pedal release system 10 is activated (i.e., released) as quickly as the impact and collapse of the dash panel.

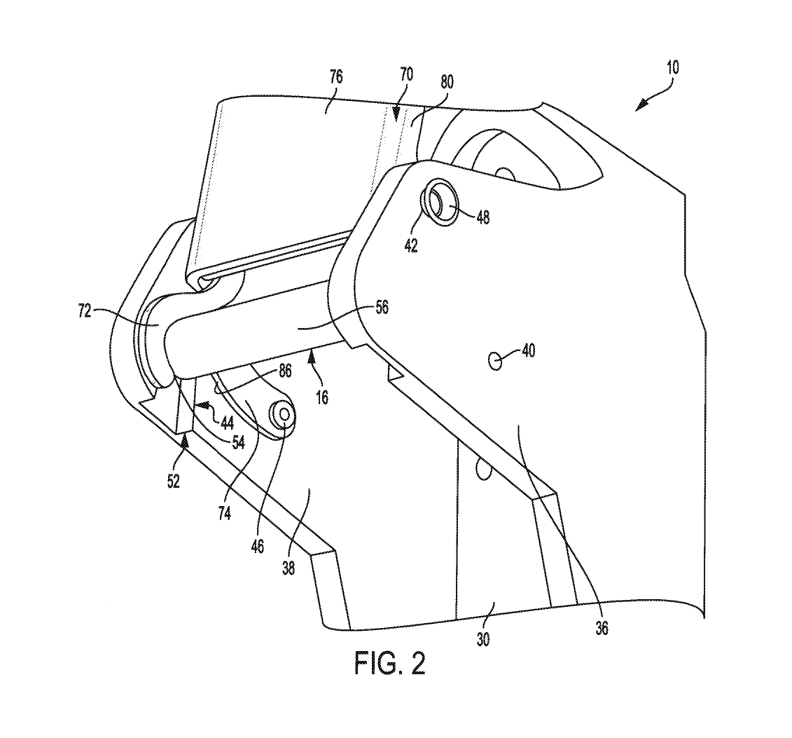

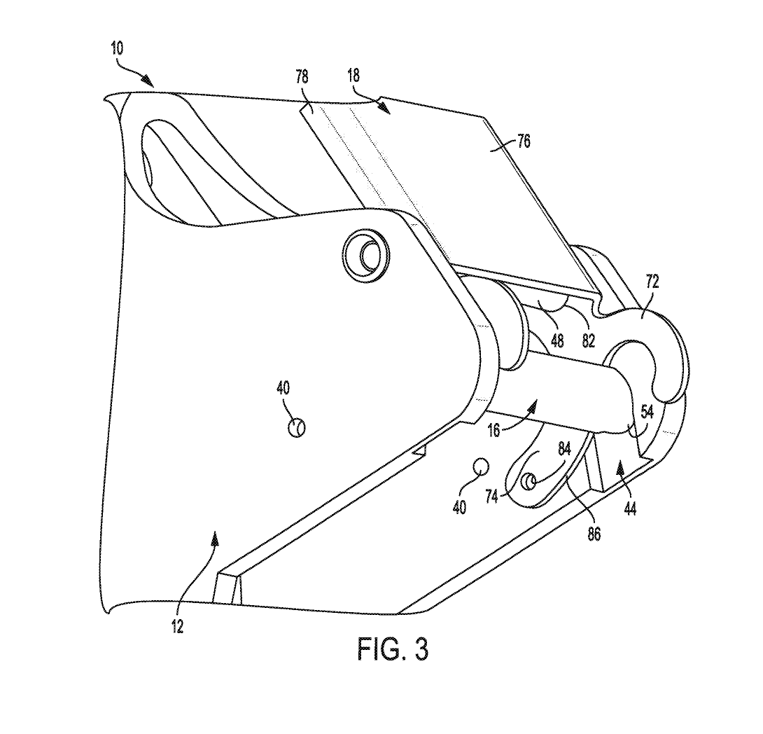

With additional reference to FIGS. 2 and 3, pedal release system 10 generally includes a brake pedal bracket 12, a pedal pivot pin 14, a brake pedal arm 16, a pedal release member or lever 18, and an activation bracket 20.

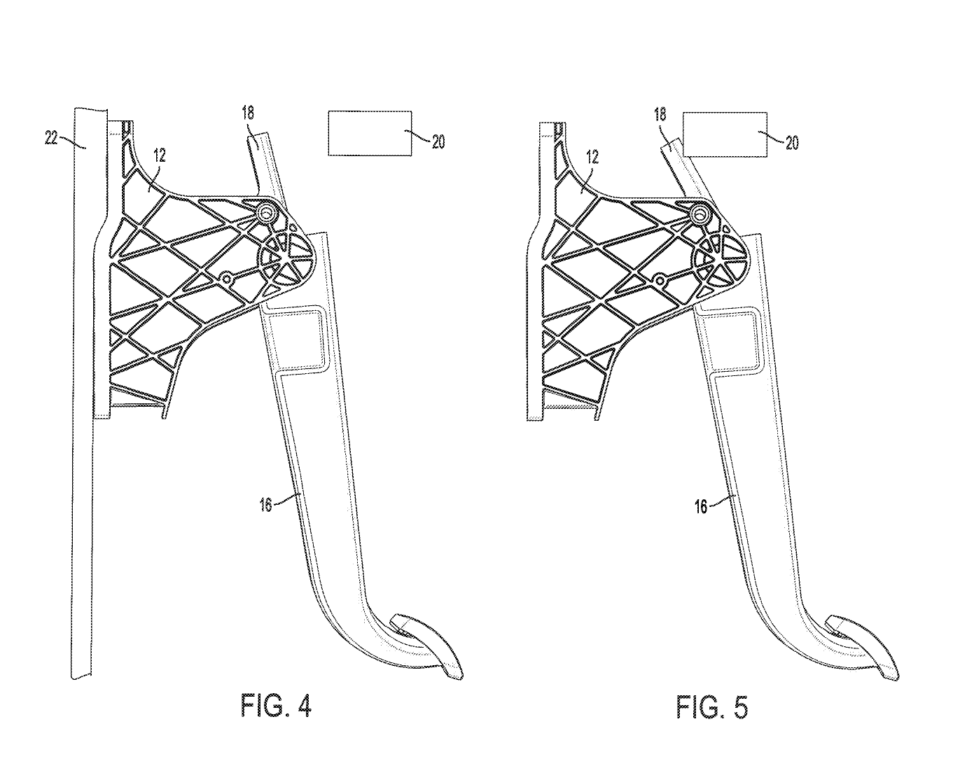

In the example embodiment, brake pedal bracket 12 is configured to couple to a vehicle dash panel 22 (see FIG. 4) and generally includes a forward wall 30, a pair of opposed sidewalls or flanges 32, and a bottom wall 34. The forward wall 30 is configured to be disposed at least partially against the vehicle dash panel 22 for coupling thereto. Flanges 32 extended outwardly from forward wall 30 generally toward a rear of the vehicle, and the bottom wall 34 is coupled to and extends between the flanges 32.

As illustrated in the example embodiment of FIGS. 1, 2 and 3, each flange 32 generally includes an outer surface 36, an inner surface 38, a first aperture 40, a second aperture 42, and an inner slot 44. The first apertures 40 are configured to receive a fuse pin 46 configured to maintain release lever 18 in a first position until a vehicle impact breaks or shears the fuse pin 46 to release the release lever 18, as will be described herein in more detail. The second apertures 42 are configured to receive a pivot pin 48, and the inner slots 44 are formed in the flange inner surface 38 and configured to receive the pedal pivot pin 14.

In the example embodiment, each inner slot 44 includes a closed end 50 and an open end 52, which enables pedal pivot pin 14 to be inserted into and removed from the inner slot 44. Moreover, open end 52 is located below closed end 50 such that pedal pivot pin 14 will be pushed out of inner slot 44 when pedal pivot pin 14 is released by release lever 18, as described herein in more detail. As illustrated in the example implementation, pedal pivot pin 14 may include ends 54 having a smaller diameter than a middle portion 56. As such, ends 54 may have a diameter sized to fit within a width of inner slot 44, and middle portion 56 may have a larger diameter sized to be received within brake pedal arm 16 and a portion of release lever 18.

In the example embodiment, brake pedal arm 16 generally includes a proximal end 60 and a distal end 62. Proximal end 60 includes an aperture 64 configured to receive pedal pivot pin 14 such that brake pedal arm 16 is rotatable about a first axis ‘A1’. Distal end 62 includes a foot pad 66 configured to receive a foot of the driver for actuation of the vehicle brakes. A booster input rod 68 is coupled to brake pedal arm 16 and is configured to provide input to a hydraulic brake booster (not shown) through the brake pedal arm 16. Although a brake pedal arm 16 is described, the pedal release system 10 described herein may be utilized with other pedals such as, for example, a clutch pedal.

In the example embodiment, pedal release lever 18 is located proximate activation bracket 20 such that during a frontal collision, as the vehicle dash panel 22 moves rearward, release lever 18 is driven into activation bracket 20, which is coupled to a stationary vehicle structure such as a cross-car beam (not shown). With further reference to FIGS. 2-5, the release lever 18 is thus movable between an unreleased home position (FIGS. 1, 2, 4) and a released position (FIGS. 3 and 5). As described herein in more detail, release lever 18 maintains pedal pivot pin 14 within inner slot 44 in the unreleased position, and allows pedal pivot pin 14 to drop out of inner slot 44 when in the released position, thereby releasing brake pedal arm 16 to fall away from the driver's legs and facilitate preventing injury during an impact event.

As illustrated in FIGS. 2 and 3, release lever 18 generally includes a contact lever 70, a first or pivot release arm 72, and a second or pivot push arm 74. In the example embodiment, contact lever 70 includes a contact face 76 extending between a pair of sidewalls 78, 80. Contact face 76 is planar or substantially planar and defines an area configured to contact activation bracket 20 during an impact event. As partially shown in FIG. 3, each sidewall 78, 80 includes an aperture 82 configured to receive pivot pin 48 therethrough such that release lever 18 is rotatable about a second pivot axis ‘A2’ when the activation bracket 20 engages contact face 76 during the impact event.

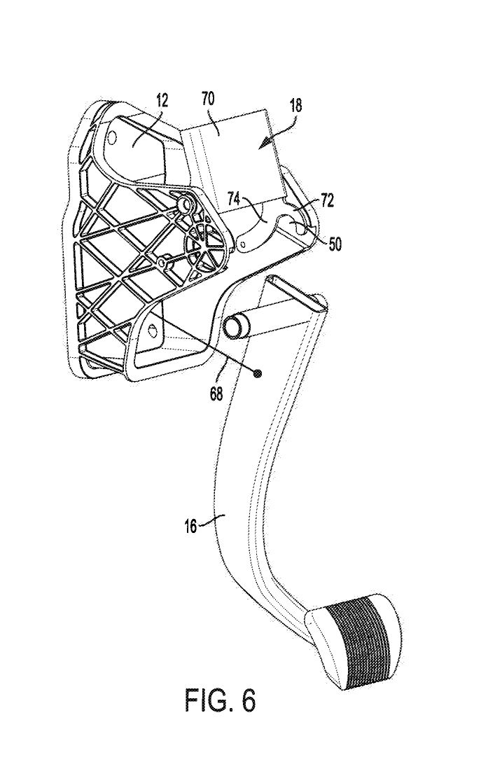

In one example implementation, pivot push arm 74 is coupled to and extends outwardly from contact lever 70, and pivot release arm 72 is coupled to and extends outwardly from pivot push arm 74. Pivot release arm 72 is generally curved or hook-shaped and is configured to be disposed about at least a portion of the pivot pin 14, as shown in FIG. 2. In this way, pivot push arm 74 facilitates movement of pivot pin 14 from inner slot 44 such that brake pedal arm 16 exits the inner slot 44 to the fully released position (FIG. 6). In some implementations, pivot release arm 72 maintains pivot pin 14 within inner slot 44 against closed end 50 by supporting the pivot pin 14 from below and/or by wedging pivot pin 14 against a wall of the inner slot 44.

As shown in FIG. 3, pivot push arm 74 includes an aperture 84 and a contact edge 86. Aperture 84 is configured to receive fuse pin 46 (see FIG. 2) to facilitate maintaining release lever 18 in the unreleased position. Contact edge 86 is configured to contact pedal pivot pin 14 and assist pushing pin 14 out of the inner slot 44 during the impact event. Accordingly, when release lever 18 is rotated to the released position both pivot push arm 74 and gravity help to push pivot pin 14 out of inner slot 44 to release brake pedal arm 16 from the brake pedal bracket 12. Once pivot pin 14 exits inner slot 44, brake pedal arm 16 is free to fall away from bracket 12 and the driver's legs to prevent injury thereto. Brake pedal arm 16, however, remains coupled to booster input rod 68 which maintains brake pedal arm 16 in close proximity to vehicle dash panel 22.

In operation, pedal release system 10 begins in the unreleased home position shown in FIGS. 1, 2, and 4. In this position, release lever 18 maintains pedal pivot pin 14 within inner slot 44 such that brake pedal arm 16 can rotate about pivot axis ‘A1’. Moreover, one or more fuse pins 46 extend through an aligned pair of apertures 40 and 84 to hold the release lever 18 in the unreleased position.

Upon a predetermined impact event (e.g., a frontal collision), vehicle dash panel 22 collapses rearward toward the driver, which in turn causes rearward movement of brake pedal bracket 12 and associated pedal release system 10 rearward toward the activation bracket 20, which is coupled to a stationary support structure of the vehicle. As such, contact face 76 of release lever 18 contacts activation bracket 20, thereby causing counter-clockwise rotation of release lever 18 about pivot axis ‘A2’ (as viewed in FIG. 5). Upon contact between contact face 76 and activation bracket 20, fuse pins 46 are sheared or otherwise break away, allowing the rotation of release lever 18 about pivot pin 48 and pivot axis ‘A2’.

In the example embodiment, as the release lever 18 moves from the unreleased position to the released position, the pivot release arm 72 moves from the first position (FIG. 2) where arm 72 supports pedal pivot pin 14 within inner slot 44, to a second position (FIG. 3) away from pivot pin 14 to provide a clear path for the pivot pin 14 to exit inner slot 44 through open end 52. As such, pivot push arm 74 and gravity may urge pivot pin 14 towards the open end 52 of inner slot 44. At the same, as the release lever 18 moves from the unreleased position to the released position, the contact edge 86 of pivot push arm 74 contacts pivot pin 14 and urges the pin towards the open end 52 of inner slot 44. As shown in FIG. 6, once pivot pin 14 exits inner slot 44 and is released from the brake pedal bracket 12, the pivot pin 14 and brake pedal arm 16 are free to rotate downward about the booster input rod 68 and fall away from the driver's legs to prevent injury.

Described herein are systems and methods for releasing a brake pedal during an impact event to prevent injury to a driver. A pedal release system includes a pedal release lever that contacts an activation bracket during the impact event. This contact causes the release lever to rotate such that a first arm enables a pedal pivot pin to release from the system while a second arm urges the pedal pivot pin away from the system, thereby releasing the brake pedal. As such, the system provides a simple mechanical release of the brake pedal that is activated based on movement of the vehicle dash panel.

It will be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A pedal release system for a vehicle, the system comprising:
a pedal bracket configured to couple to a vehicle dash panel;
a pivot pin received within the pedal bracket and defining a first rotational axis;
a pedal arm configured to rotate about the first rotational axis;
an activation bracket coupled to a stationary structural component of the vehicle; and
a pedal release lever coupled to the pedal bracket and movable between a first position and a second position, the pedal release lever having a contact lever, a pivot release arm, and a pivot push arm, wherein in the first position the pivot release arm facilitates maintaining the pivot pin within the pedal bracket, and
wherein upon an impact event where the contact lever is brought into contact with the activation bracket, the pedal release lever is moved to the second position where the pivot push arm urges the pivot pin out of the pedal bracket to release the pedal arm from the pedal bracket so as to prevent intrusion of the pedal arm into a passenger area of an interior of the vehicle.

2. The system of claim 1, wherein the pivot push arm includes a first aperture configured to align with a second aperture formed in the pedal bracket, the first and second apertures configured to receive a pin configured to maintain the pedal release lever in the first position.

3. The system of claim 2, wherein the pin is configured to shear away when the pedal release lever contacts the activation bracket during the impact event such that the pedal release lever moves to the second position.

4. The system of claim 1, further comprising a lever pivot pin coupled to the pedal bracket, the pedal release lever rotatably coupled to the lever pivot pin such that the pedal release lever is movable from the first position to the second position.

5. The system of claim 4, wherein the lever pivot pin defines a second rotational axis different than the first rotational axis.

6. The system of claim 1, wherein the pivot push arm is coupled to and extends from the contact lever.

7. The system of claim 6, wherein the pivot release arm is coupled to and extends from the pivot push arm.

8. The system of claim 1, wherein the pedal bracket includes a slot configured to receive the pivot pin.

9. The system of claim 8, wherein the slot includes a closed end and an open end configured to enable the pivot pin to enter and exit the slot.

10. The system of claim 9, wherein the pedal bracket includes a pair of spaced apart flanges each having an outer surface and an inner surface, wherein the slot is formed on the inner surface of each flange.

11. The system of claim 1, wherein the pivot release arm is generally hook-shaped and is configured to be disposed about at least a portion of the pivot pin.

12. The system of claim 1, wherein the contact lever defines a generally planar contact face configured to contact the activation bracket during the impact event.

13. The system of claim 1, wherein the pedal arm is a brake pedal arm.

14. The system of claim 1, wherein the pedal arm is a clutch pedal arm.

15. A vehicle comprising:
a dash panel; and
a pedal release system including:
a pedal bracket coupled to the dash panel;
a pivot pin received within the pedal bracket and defining a first rotational axis;
a pedal arm configured to rotate about the first rotational axis;
an activation bracket coupled to a stationary structural component of the vehicle; and
a pedal release lever coupled to the pedal bracket and movable between a first position and a second position, the pedal release lever having a contact lever, a pivot release arm, and a pivot push arm, wherein in the first position the pivot release arm facilitates maintaining the pivot pin within the pedal bracket, and
wherein upon an impact event where the contact lever is brought into contact with the activation bracket, the pedal release lever is moved to the second position where the pivot push arm urges the pivot pin out of the pedal bracket to release the pedal arm from the pedal bracket so as to prevent intrusion of the pedal arm into a passenger area of an interior of the vehicle.

16. The vehicle of claim 15, wherein the pedal arm is a brake pedal arm.

17. The vehicle of claim 15, wherein the pivot push arm includes a first aperture configured to align with a second aperture formed in the pedal bracket, the first and second apertures configured to receive a pin configured to maintain the pedal release lever in the first position; and
wherein the pin is configured to shear away when the pedal release lever contacts the activation bracket during the impact event such that the pedal release lever moves to the second position.

18. The vehicle of claim 15, wherein the pedal bracket includes a slot configured to receive the pivot pin;
wherein the slot includes a closed end and an open end configured to enable the pivot pin to enter and exit the slot; and
wherein the pedal bracket includes a pair of spaced apart flanges each having an outer surface and an inner surface, wherein the slot is formed on the inner surface of each flange.
